(19) United States
(12) Patent Application Publication
(10) Pub. No.: US 2024/0417015 A1
(43) Pub. Date: Dec. 19, 2024

(54) SADDLEBAGS SUPPORT DEVICE CONFIGURED TO ATTACH TO A REAR SEAT COWL POSITION WELL OF A SPORT BIKE

(71) Applicant: Charlie Denne Anthony, Hildebran, NC (US)

(72) Inventor: Charlie Denne Anthony, Hildebran, NC (US)

(21) Appl. No.: 18/210,182

(22) Filed: Jun. 15, 2023

(51) Int. Cl. B62J 9/27; B62J 9/26

(52) U.S. Cl. CPC B62J 9/27; B62J 9/26

(57) ABSTRACT

A support saddlebags device configured to attach to a rear seat cowl position well of a motorcycle or a sport bike includes a bottom portion and a top portion. The bottom portion is configured to be removably attached to the rear seat cowl position well of the motorcycle or the sport bike. The top portion is connected to the bottom portion. The top portion is configured to attach saddlebags on the saddlebags support device while positioned in the rear seat cowl position well of the motorcycle or the sport bike.

### FIELD OF THE DISCLOSURE

The present disclosure relates to motorcycles, sport bikes and saddlebags therefore. More specifically, the present disclosure relates to a saddlebags support device configured to attach to the rear seat cowl position well of a sport bike, or other motorcycle.

### BACKGROUND

Generally speaking, a saddlebag is one of a pair of covered pouches laid across the back of a horse behind the saddle or hanging over the rear wheel of a bicycle or motorcycle. In horse riding, saddlebags sit in various positions, on the back, side, or front of the saddle. Most attach to the saddle by straps and ties. They can be made from various materials. There are several types: Pommel bags (which sit in front of the saddle), traditional paired saddlebags (which lie on the hips of the horse, on either side of the cantle), and assorted smaller bags such as a cantle bag (a small tube-like bag that sits just behind the saddle), or a single small saddle bag that may be carried on the off-side (right hand side) of an English saddle. In bicycling, a saddlebag or seat bag is a bag attached under the saddle or seat. Smaller bags are typically used to hold a few items such as spare inner tubes, puncture repair kit, tools, rain gear, food, first-aid kit, etc. Seat bags are common on touring bicycles, racing bicycles, and cross-country mountain bikes. Saddlebags range in sizes from small to large. Smaller bags, known as seat bags, wedge packs, or seat packs fit completely under the saddle. Larger bags which project behind and sideways are usually called saddlebags.

On a motorcycle, modern saddlebags are normally hard-shell cases mounted behind the seat and on either-side of the rear wheel. However, motorcycle saddlebags can also come in soft bag pannier-style form that are fitted over the back portion of the motorcycle and then strapped down. Motorcycle saddlebags also are available as modern motorcycle accessories to place across the rear portion of the motorcycle seat. They can then be carried over the arm or shoulder of the rider once detaches. Made of leather or vinyl (leathercloth or imitation leather) with stiffening, they are known as throwovers and come in different shapes and sizes to be used as travel luggage or a handy temporary container for items such as shopping.

The instant disclosure recognizes the problem associated with known motorcycle saddlebags in that they require some form of a frame to be installed on the rear portion of the motorcycle for securing the saddlebag to the motorcycle. Both hard-shell and soft motorcycle saddlebags are typically attached to a framework (which bolts to the motorcycle frame) known as a carrier. This framework or carrier has to be installed on the motorcycle frame via welding, drilling holes, etc. in order for the saddlebags to be secured to the motorcycle when attached to such framework or carrier. For most motorcycle owners, the installation of the framework or carrier may require a special third party installer which costs additional money. In addition, because of the welding or holes required, the installation of the framework or carrier for the saddlebags may be irreversible due to the damage of the appearance or function of the motorcycle frame when uninstalled. This is clearly not desired. As such, there is clearly a need to provide a motorcycle saddlebag device or system that is easily installed and removed from the motorcycle.

In addition, the instant disclosure recognizes the time and effort it takes to secure saddlebags to the saddlebag supports on the motorcycle and/or to remove the saddlebags from the saddlebag supports on the motorcycle. As such, there is clearly a need and/or desire to provide a device or means for quickly securing and/or removing saddlebags from the saddlebags supports on a motorcycle.

The instant disclosure may be designed to address at least certain aspects of the problems or needs discussed above by providing a saddlebags support device configured to attach to the rear seat cowl position well of a sport bike.

### SUMMARY

The present disclosure may solve the aforementioned limitations of the currently available saddlebag supports and systems for motorcycles, including, but not limited to sports bikes, by providing a saddlebags support device configured to attach to the rear seat cowl position well of a sport bike. The saddlebags support device configured to attach to the rear seat cowl position well of a sport bike may generally include a bottom portion and a top portion. The bottom portion may be configured to be removably attached to the rear seat cowl position well of the motorcycle or the sport bike. The top portion may be connected to the bottom portion. The top portion may be configured to attach saddlebags on the saddlebags support device while positioned in the rear seat cowl position well of the motorcycle, including, but not limited to, a sport bike.

One feature of the disclosed saddlebags support device may be that it can be designed and/or configured to be used in the rear seat cowl position well on any motorcycle or the like device, like an ATV, etc. Wherein, the bottom portion of the saddlebags support device may be configured to attach to the rear seat cowl position well of any motorcycle or the like device, like an ATV, etc. As such, the top portion of the saddlebags support device may be configured to attach the saddlebags on the saddlebags support device while positioned in the rear seat cowl position well of any motorcycle or the like device, like an ATV, etc.,

In select embodiments of the disclosed saddlebags support device, it can be designed and/or configured to be used in the rear seat cowl position well on a sport bike (like a Yamaha YZF-R1® provided by Yamaha Motor Company of Cypress, CA (as shown in the Figures), a Kawasaki® Ninja® provided by Kawasaki Motors Corp. of Santa Ana, CA, a Honda® sportbike provided by American Honda Motor Co. of Alpharetta, GA, a Suzuki® sportbike provided by Suzuki Motor USA, LLC of Brea, CA, a Ducati® Sportbike provided by Ducata North America of Cupertina, CA, a BMW® sportbike provided by BMW of North America, LLC of Woodcliff Lake, NJ, or the like). In these embodiments, the bottom portion of the saddlebags support device may be configured to attach the saddlebags on the saddlebags support device while positioned in the rear seat cowl position well of the sport bike. As such, the top portion of the saddlebags support device may be configured to attach the saddlebags on the saddlebags support device while positioned in the rear seat cowl position well of the sport bike.

Another feature of the disclosed saddlebags support device may be that the bottom portion can include a plurality of standard connection points. These standard connection points may be configured to secure the bottom portion in the rear seat cowl position well, similar to an OEM rear seat or rear seat cowl. In select embodiments of the disclosed saddlebags support device, the plurality of standard connection points may include a first hook receiver, a second hook receiver, and a locking tab. The first hook receiver may be positioned approximate a back end of the bottom portion approximate a first bottom side of the bottom portion. The first hook receiver may be configured to receive a first securing hook in the rear seat cowl position well. The second hook receiver may be positioned approximate the back end of the bottom portion approximate a second bottom side of the bottom portion. The second hook receiver may be configured to receive a second securing hook in the rear seat cowl position well. The locking tab may extended from the bottom portion and may be positioned approximate a front end of the bottom portion. The locking tab may be configured to engage a lock in the rear seat cowl position well. Whereby, when the bottom portion of the saddlebags support device is positioned in the rear seat cowl position well with the first securing hook inserted into the first hook receiver and the second securing hook inserted into the second hook receiver, the bottom portion of the saddlebags support device may be configured to be locked into the rear seat cowl position well via the lock engaging the locking tab under the bottom portion. In addition, when the lock is disengaged from the locking tab, the saddlebags support device may be configured to be removed from the rear seat cowl position well.

Another feature of the disclosed saddlebags support device may be that the top portion can include a mounting plate. The mounting plate may be configured to mount at least one saddlebag support bracket to the top portion. Each of the at least one saddlebag support brackets may be configured to mount a saddlebag thereto.

In select embodiments of the disclosed saddlebags support device, the at least one saddlebag support bracket may include a first u-shaped bracket and a second u-shaped bracket. The first u-shaped bracket may include a first horizontal starting portion connected to a first side of the mounting plate and extending horizontally therefrom the first side of the mounting plate. A first vertical ending portion may extend vertically down from the first horizontal starting portion. At least one first bend may be included between the first horizontal starting portion and the first vertical ending portion. Likewise, the second u-shaped bracket may include a second horizontal starting portion connected to a second side of the mounting plate and extending horizontally therefrom the second side of the mounting plate. A second vertical ending portion may extend vertically down from the second horizontal starting portion. At least one second bend may be included between the second horizontal starting portion and the second vertical ending portion.

In select embodiments of the disclosed saddlebags support device, the first u-shaped bracket may include an upper first bend with an upper first cross bar, a lower first bend with a lower first cross bar, and a first ending cross bar at a first bottom of the first u-shaped bracket. Likewise, the second u-shaped bracket may include an upper second bend with an upper second cross bar, a lower second bend with a lower second cross bar, and a second ending cross bar at a second bottom of the second u-shaped bracket.

In other select embodiments of the disclosed saddlebags support device, the first u-shaped bracket may include a plurality of first angled connector bars connected in each first corner between the lower first cross bar and the first ending cross bar. Wherein, the upper first cross bar, the lower first cross bar, the first ending cross bar, and the plurality of first angled connector bars may be configured to provide a plurality of first attachment locations for saddlebags to be mounted to the first u-shaped bracket on the saddlebags support device. Likewise, the second u-shaped bracket may include a plurality of second angled connector bars connected in each second corner between the lower second cross bar and the second ending cross bar. Wherein, the upper second cross bar, the lower second cross bar, the second ending cross bar, and the plurality of second angled connector bars are configured to provide a plurality of second attachment locations for saddlebags to be mounted to the second u-shaped bracket on the saddlebags support device.

In other select embodiments of the disclosed saddlebags support device, the first u-shaped bracket may include a first mounting rack. The first mounting rack may be positioned approximate a first distal end of the first u-shaped bracket. The first mounting rack may include a plurality of first holes and a plurality of first slots configured for mounting saddlebags to the first u-shaped bracket. Likewise, the second u-shaped bracket may include a second mounting rack. The second mounting rack may be positioned approximate a second distal end of the second u-shaped bracket. The second mounting rack may include a plurality of second holes and a plurality of second slots configured for mounting saddlebags to the second u-shaped bracket.

In other select embodiments of the disclosed saddlebags support device, the first u-shaped bracket may include a plurality of first cross bars, and first vertical open ended bars on each side of the first u-shaped bracket. The first vertical open ended bars may be configured to be positioned in first vertical slots in custom saddlebags for the first u-shaped bracket. The first cross bars may be configured to receive first horizontal attachment means on the custom saddlebags. Likewise, the second u-shaped bracket may include plurality of second cross bars, and second vertical open ended bars on each side of the second u-shaped bracket. The second vertical open ended bars may be configured to be positioned in second vertical slots in the custom saddlebags for the second u-shaped bracket. The second cross bars may be configured to receive second horizontal attachment means on the custom saddlebags.

In other select embodiments of the disclosed saddlebags support device, the first u-shaped bracket may include a first front end and a first back end. The first front end and the first back end may be affixed between the mounting plate and the bottom portion. Likewise, the second u-shaped bracket may include a second front end and a second back end. The second front end and the second back end may be affixed between the mounting plate and the bottom portion. In select embodiments, the first front end of the first u-shaped bracket may include a plurality of first front end holes, wherein the first front end is affixed between the mounting plate and the bottom portion via a plurality of first front end mechanical fasteners positioned through the plurality of first front end holes. Likewise, the first back end of the first u-shaped bracket may include a plurality of first back end holes, wherein the first back end is affixed between the mounting plate and the bottom portion via a plurality of first back end mechanical fasteners positioned through the plurality of first back end holes. Likewise, the second front end of the second u-shaped bracket may include a plurality of second front end holes, wherein the second front end may be affixed between the mounting plate and the bottom portion via a plurality of second front end mechanical fasteners positioned through the plurality of second front end holes. Likewise, the second back end of the second u-shaped bracket may include a plurality of second back end holes, wherein the second back end may be affixed between the mounting plate and the bottom portion via a plurality of second back end mechanical fasteners positioned through the plurality of second back end holes. In select embodiments, the first front end mechanical fasteners may include first front end bolts and nuts with first front end spacers between the first front end and the bottom portion. Likewise, the first back end mechanical fasteners may include first back end bolts and nuts with first back end spacers between the first back end and the bottom portion. Likewise, the second front end mechanical fasteners may include second front end bolts and nuts with second front end spacers between the second front end and the bottom portion. Likewise, the second back end mechanical fasteners may include second back end bolts and nuts with second back end spacers between the second back end and the bottom portion.

Another feature of the disclosed saddlebags support device may be that the mounting plate can include a plurality of openings. The plurality of openings in the mounting plate may be positioned approximately around a perimeter of the mounting plate. The plurality of openings may be configured to provide a plurality of connection points for securing saddlebags on the saddlebag support brackets.

Another feature of the disclosed saddlebags support device may be that the mounting plate can include a plurality of angles around a perimeter of the mounting plate. The plurality of angles may be configured for providing various strapping angles for mounting saddle bags on the saddlebags support device.

In other select embodiments of the disclosed saddlebags support device, the top portion may include a mounting ring. The mounting ring may include a rear seat or a seat cowl attached thereto on the top portion. The mounting ring may be configured to mount saddlebag support brackets to said top portion. The saddlebag support brackets may be configured to mount saddlebags thereto.

Another feature of the disclosed saddlebags support device may be that the saddlebags support device does not require any modification to a motorcycle or a sport bike for securing the saddlebag support device to the motorcycle or the sport bike.

Another feature of the disclosed saddlebags support device may be that the saddlebags support device may be removed from the motorcycle with the saddlebags attached thereto.

In another aspect, the instant disclosure embraces the disclosed saddlebags support device in any of the various embodiments and/or combinations of embodiments shown and/or described herein.

In another aspect, the instant disclosure embraces a saddlebags support device configured to attach to a rear seat cowl position well of a sport bike including a bottom portion and a top portion. The bottom portion may be configured to attach to the rear seat cowl position well of the sport bike. The top portion may be connected to the bottom portion. As a result, the top portion may be configured to attach the saddlebags on the saddlebags support device while positioned in the rear seat cowl position well of the sport bike.

In another aspect, the instant disclosure embraces a support device configured to attach to a rear seat cowl position well of a motorcycle including a bottom portion and a top portion. The bottom portion may be configured to attach to the rear seat cowl position well of the motorcycle. The top portion may be connected to the bottom portion. The top portion may include a mounting plate. The mounting plate may include a plurality of openings and/or a plurality of angles. The plurality of openings in the mounting plate may be around a perimeter of the mounting plate. The plurality of openings may be configured to provide a plurality of connection points configured for securing luggage, saddlebags, or other hauled objects on the mounting plate. The plurality of angles may be around a perimeter of the mounting plate. The plurality of angles may be configured for providing various strapping angles for mounting the luggage, the saddlebags or the other hauled objects on the mounting plate.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a side view of a motorcycle with a cushioned back seat according to the prior art positioned in the rear seat cowl position well;

FIG. 2 is a side view of a motorcycle with a seat cowl according to the prior art positioned in the rear seat cowl position well;

FIG. 3 is the underside of a cushioned back seat from FIG. 1 or a seat cowl of FIG. 2 according to the prior art showing the standard connection points for positioning in the rear seat cowl position well;

FIG. 4 is a perspective view of the saddlebags support device configured to attach to the rear seat cowl position well of a sport bike according to select embodiments of the instant disclosure;

FIG. 5 is a partially disassembled perspective view of the saddlebags support device configured to attach to the rear seat cowl position well of a sport bike of FIG. 4;

FIG. 6 is a side view of a sport bike motorcycle with saddlebags support device configured to attach to the rear seat cowl position well of a sport bike of FIG. 4 installed thereon;

FIG. 7 is a bottom view of the saddlebags support device configured to attach to the rear seat cowl position well of a sport bike according to select embodiments of the instant disclosure showing the standard connection points for positioning the device in the rear seat cowl position well;

FIG. 8 is a perspective view of another embodiment of the saddlebags support device configured to attach to the rear seat cowl position well of a sport bike according to select embodiments of the instant disclosure;

FIG. 9 is a perspective view of another embodiment of the saddlebags support device configured to attach to the rear seat cowl position well of a sport bike according to select embodiments of the instant disclosure;

FIG. 10 is a partially disassembled view of the saddlebags support device configured to attach to the rear seat cowl position well of a sport bike of FIG. 9 shown with a saddlebag system designed to fit on this embodiment of the device; and

FIG. 11 is a perspective view of another embodiment of the saddlebags support device configured to attach to the rear seat cowl position well of a sport bike according to select embodiments of the instant disclosure with an attachment ring.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

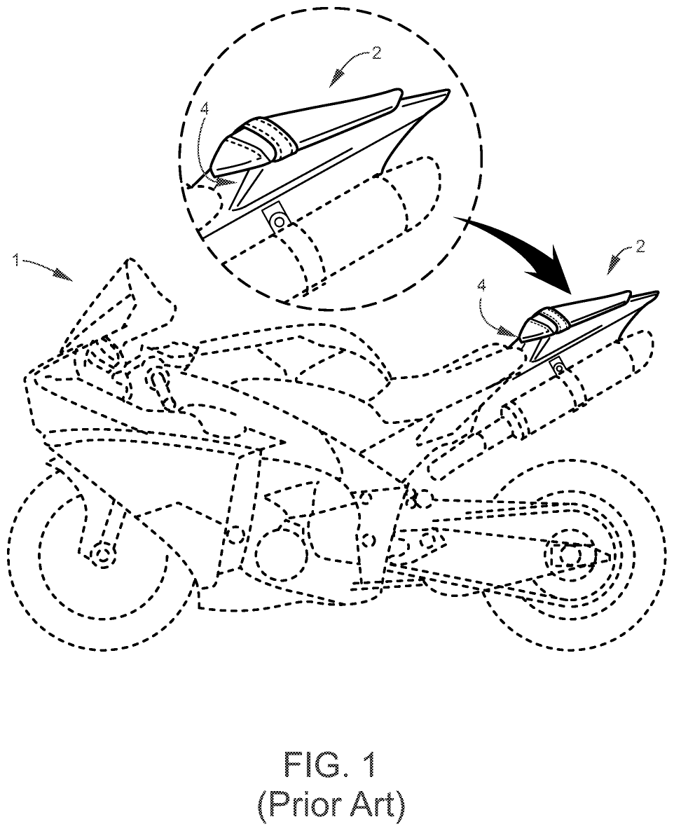

Referring now to FIGS. 1-11, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

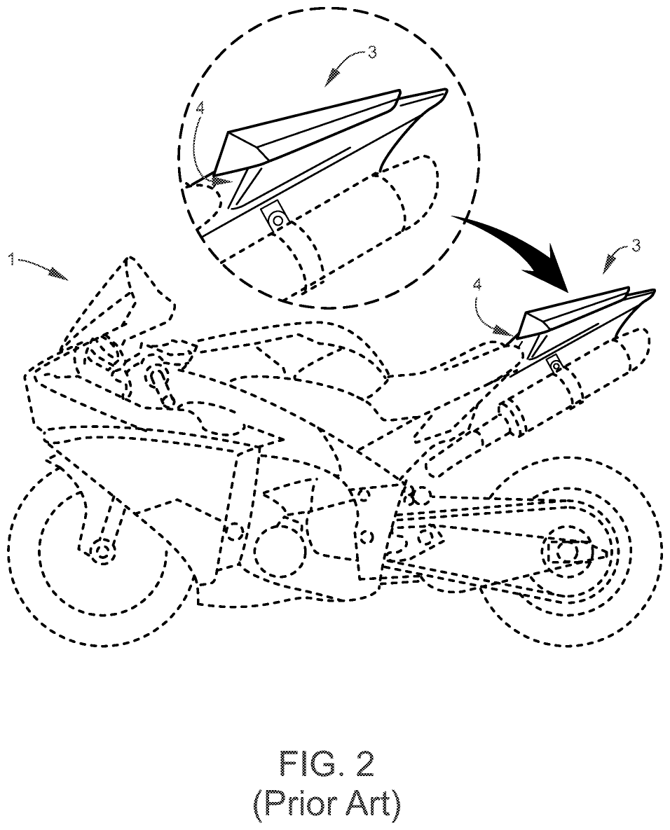

Referring first to FIGS. 1-3, a prior art motorcycle or sport bike 1 is shown. This motorcycle or sport bike 1 may include a rear seat 2 (see FIG. 1) or a rear seat cowl 3 (see FIG. 2) that is positioned in a rear seat cowl position well 4. This rear seat cowl position well 4 may be a standard OEM rear seat cowl position well 4 and the rear seat 2 or the rear seat cowl 3 may be locked into the standard OEM rear seat cowl position well 4 by standard OEM connection points 5 that are positioned on the bottom of the rear seat 2 and the rear seat cowl 3. Although the size and orientation of rear seat cowl position well 4 may be unique for various models and manufactures of motorcycles or sport bikes 1, the typically include a standard first hook receiver 6, a standard second hook receiver 7, and a standard locking tab 8. The standard first hook receiver 6 may be positioned approximate the back end of the bottom portion of the standard rear seat 2 or standard rear seat cowl 3 approximate a first side. The first hook receiver 6 may be configured to receive a first securing hook in the rear seat cowl position well 4. The second hook receiver 7 may be positioned approximate the back end of the bottom portion of the standard rear seat 2 or standard rear set cowl 3. The second hook receiver 7 may be configured to receive a second securing hook in the standard rear seat cowl position well 4. The standard locking tab 8 may extended from the bottom of the rear seat 2 or standard rear set cowl 3 and may be positioned approximate a front end. The locking tab 8 may be configured to engage a lock in the standard rear seat cowl position well 4. In most sport bikes, this positioning well lock may be operated via a key. Whereby, when the bottom of the standard rear seat 2 or standard rear set cowl 3 is positioned in the standard rear seat cowl position well 4 with the first securing hook inserted into the standard first hook receiver 6 and the second securing hook inserted into the standard second hook receiver 7, the bottom of the standard rear seat 2 or standard rear set cowl 3 may be configured to be locked into the standard rear seat cowl position well 4 via the lock engaging the standard locking tab 8 under the bottom of the standard rear seat 2 or standard rear set cowl 3. In addition, when the lock is disengaged from the standard locking tab 8 (like via a key), the standard rear seat 2 or standard rear set cowl 3 may be removed from the standard rear seat cowl position well 4.

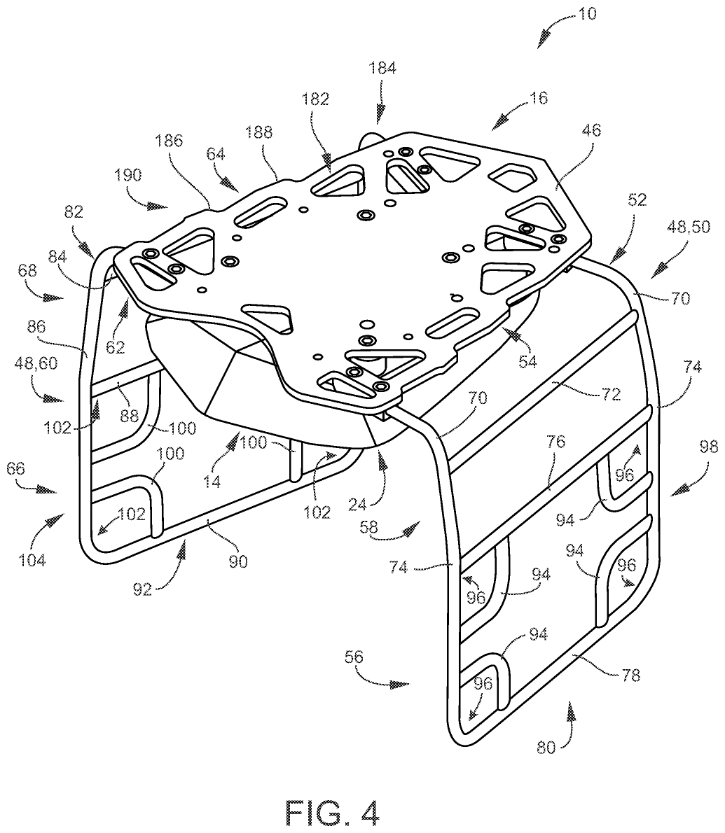

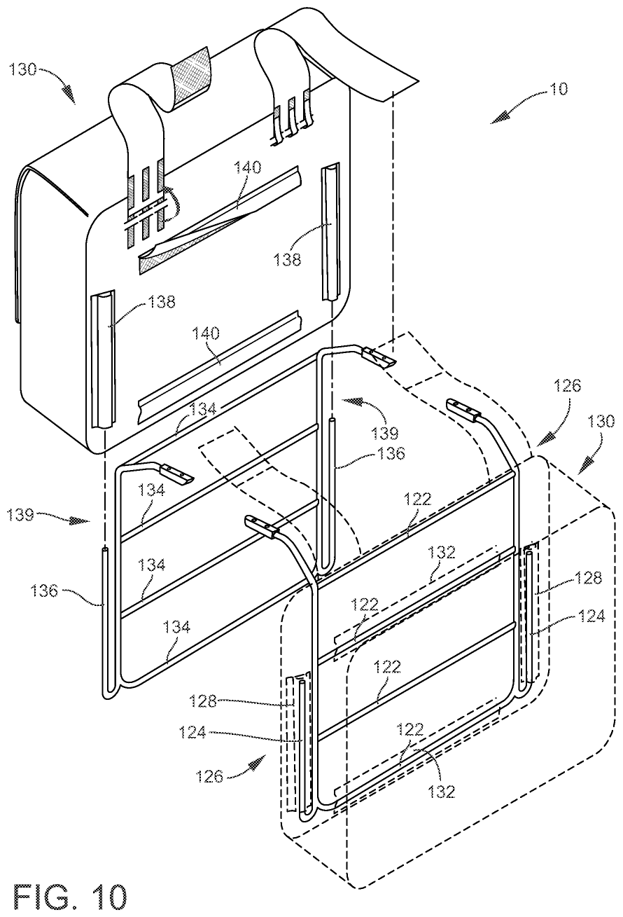

Referring now to FIGS. 4-11, the present disclosure may solve the aforementioned limitations of the currently available saddlebag supports and systems for motorcycles, including, but not limited to sports bikes, by providing saddlebags support device 10. Saddlebags support device 10 may be designed and/or configured to attach to the rear seat cowl position well 12 of motorcycle 20, like sport bike 22 shown in the Figures. However, the disclosure is not so limited and saddlebags support device 10 may be designed, configured and/or used on any motorcycle or the like device with a rear seat cowl position well. Saddlebags support device 10 may generally include bottom portion 14 and top portion 16. Bottom portion 14 may be configured to be removably attached to rear seat cowl position well 12 of motorcycle 20, like sport bike 22 shown in the Figures. Top portion 16 may be connected to bottom portion 14. Top portion 16 may be configured to attach saddlebags 18 (see FIG. 10) on saddlebags support device 10 while positioned in rear seat cowl position well 12 of motorcycle 20, including, but not limited to, sport bike 22, as shown in the Figures.

One feature of the disclosed saddlebags support device 10 may be that it can be designed and/or configured to be used in rear seat cowl position well 12 on any motorcycle 20 or the like device, like an ATV, etc. Wherein, bottom portion 14 of saddlebags support device 10 may be configured to attach to rear seat cowl position well 12 of any motorcycle or the like device, like an ATV, etc. As such, top portion 16 of saddlebags support device 10 may be configured to attach saddlebags 18 on saddlebags support device 10 while positioned in rear seat cowl position well 12 of any motorcycle 20 or the like device, like an ATV, etc., including, but not limited to, sport bike 22, as shown in the Figures.

As shown in the Figures, in select embodiments of the disclosed saddlebags support device 10, it can be designed and/or configured to be used in rear seat cowl position well 12 on sport bike 22 (like a Yamaha YZF-R1® provided by Yamaha Motor Company of Cypress, CA (as shown in the Figures), a Kawasaki® Ninja® provided by Kawasaki Motors Corp. of Santa Ana, CA, a Honda® sportbike provided by American Honda Motor Co. of Alpharetta, GA, a Suzuki® sportbike provided by Suzuki Motor USA, LLC of Brea, CA, a Ducati® Sportbike provided by Ducata North America of Cupertina, CA, a BMW® sportbike provided by BMW of North America, LLC of Woodcliff Lake, NJ, or the like). In these embodiments, bottom portion 14 of saddlebags support device 10 may be configured to attach saddlebags 18 on saddlebags support device 10 while positioned in rear seat cowl position well 12 of sport bike 22. As such, top portion 16 of saddlebags support device 10 may be configured to attach saddlebags 18 on saddlebags support device 10 while positioned in rear seat cowl position well 12 of sport bike 22.

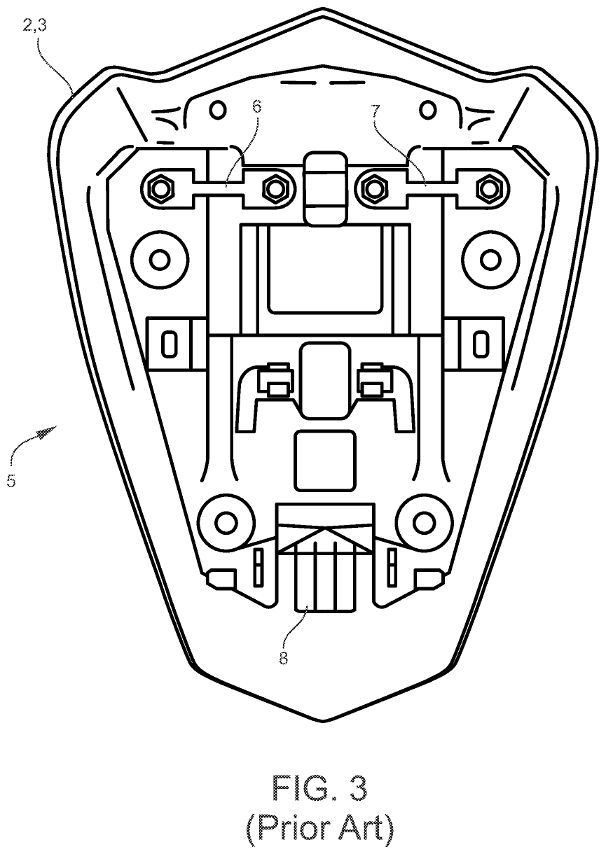

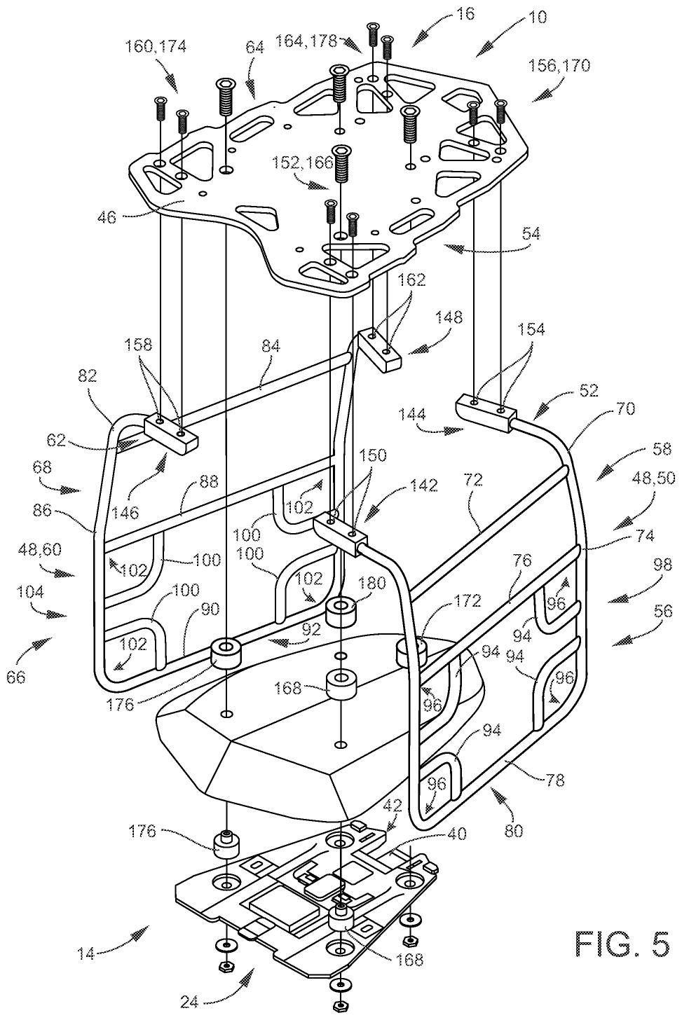

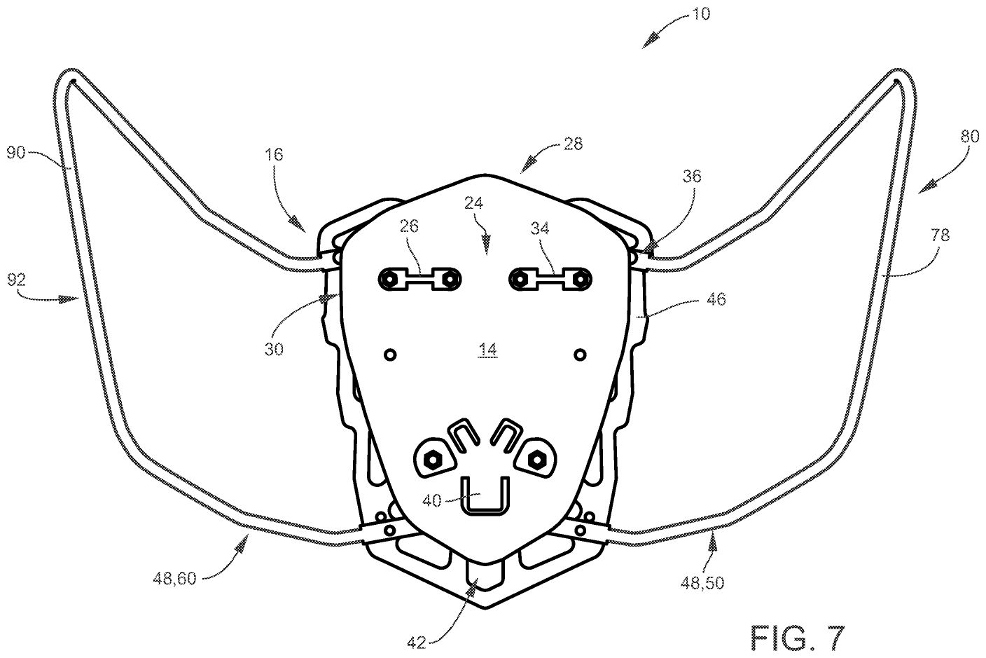

Referring now specifically to FIG. 7, another feature of the disclosed saddlebags support device 10 may be that bottom portion 14 can include a plurality of standard connection points 24. These standard connection points 24 may be configured to secure bottom portion 14 in the rear seat cowl position well 12, similar to an OEM rear seat or rear seat cowl (like as shown in FIGS. 1-3). In select embodiments of the disclosed saddlebags support device 10, the plurality of standard connection points 24 may include, but are not limited to, first hook receiver 26, second hook receiver 34, and locking tab 40. First hook receiver 26 may be positioned approximate back end 28 of bottom portion 14 approximate first bottom side 30 of bottom portion 14. First hook receiver 26 may be configured to receive first securing hook 32 in rear seat cowl position well 12 of sport bike 22, or the like. Second hook receiver 34 may be positioned approximate back end 28 of bottom portion 14 approximate second bottom side 36 of bottom portion 14. Second hook receiver 34 may be configured to receive second securing hook 38 in rear seat cowl position well 12. Locking tab 40 may extended from bottom portion 14 and may be positioned approximate front end 42 of bottom portion 14. Locking tab 40 may be configured to engage lock 44 in rear seat cowl position well 12. Whereby, when bottom portion 14 of saddlebags support device 10 is positioned in rear seat cowl position well 12 with first securing hook 32 inserted into first hook receiver 26 and second securing hook 38 inserted into second hook receiver 34, bottom portion 14 of saddlebags support device 10 may be configured to be locked into rear seat cowl position well 12 via lock 44 engaging locking tab 40 under bottom portion 14. In addition, when lock 44 is disengaged from locking tab 40, saddlebags support device 10 may be configured to be removed from rear seat cowl position well 12. As shown in FIG. 5, in select embodiments bottom portion 14 of saddlebag support device 10 may include a standard OEM connection plate or mounting piece, like as shown in FIG. 3 for connecting bottom portion 14 of saddlebag support device 10 into rear seat cowl position well 12. However, the disclosure is not so limited, and a custom connection plate or mounting piece may be included on bottom portion 14 of saddlebag support device 10, as shown in FIG. 7. As shown in FIG. 7, this custom connection plate or mounting piece may be customized to include the same standard connection points 24 as the OEM connection plate or mounting piece, like as shown in FIGS. 3 and 5, including, but not limited to, first hook receiver 26, second hook receiver 34 and locking tab 40.

Referring now to FIGS. 4-9, another feature of the disclosed saddlebags support device 10 may be that top portion 16 can include mounting plate 46. Mounting plate 46 may be configured to mount at least one saddlebag support bracket 48 to top portion 16. Each of the at least one saddlebag support brackets 48 may be configured to mount a saddlebag 18 thereto.

Still referring to FIGS. 4-9, in select embodiments of the disclosed saddlebags support device 10, the at least one saddlebag support bracket 48 may include first u-shaped bracket 50 and second u-shaped bracket 60. However, the disclosure is not so limited, and various other shapes and/or sizes of saddlebag support brackets 48 may be included. The first u-shaped bracket 50 may include first horizontal starting portion 52 connected to first side 54 of mounting plate 46 and extending horizontally therefrom first side 54 of mounting plate 46. A first vertical ending portion 56 may extend vertically down from first horizontal starting portion 52. At least one first bend 58 may be included between first horizontal starting portion 52 and first vertical ending portion 56. The first bends 58 may be designed and configured to shape first u-shaped bracket 50 around the body or frame of sport bike 22. Likewise, second u-shaped bracket 60 may include second horizontal starting portion 62 connected to second side 64 of mounting plate 46 and extending horizontally therefrom second side 64 of mounting plate 46. Second vertical ending portion 66 may extend vertically down from second horizontal starting portion 62. At least one second bend 68 may be included between second horizontal starting portion 62 and second vertical ending portion 66. The second bends 68 may be designed and configured to shape second u-shaped bracket 60 around the body or frame of sport bike 22.

Referring now specifically to FIGS. 4-6, in select embodiments of the disclosed saddlebags support device 10, first u-shaped bracket 50 may include upper first bend 70 with upper first cross bar 72, lower first bend 74 with lower first cross bar 76, and first ending cross bar 78 at first bottom 80 of first u-shaped bracket 50. Likewise, second u-shaped bracket 60 may include upper second bend 82 with upper second cross bar 84, lower second bend 86 with lower second cross bar 88, and second ending cross bar 90 at second bottom 92 of second u-shaped bracket 60.

Still referring specifically to FIGS. 4-6, in other select embodiments of the disclosed saddlebags support device 10, first u-shaped bracket 50 may include a plurality of first angled connector bars 94 connected in each first corner 96 between lower first cross bar 76 and first ending cross bar 78. Wherein, upper first cross bar 72, lower first cross bar 76, first ending cross bar 78, and the plurality of first angled connector bars 94 may be configured to provide a plurality of first attachment locations 98 for saddlebags 18 to be mounted to first u-shaped bracket 50 on saddlebags support device 10. Likewise, second u-shaped bracket 60 may include a plurality of second angled connector bars 100 connected in each second corner 102 between lower second cross bar 88 and second ending cross bar 90. Wherein, upper second cross bar 84, lower second cross bar 88, second ending cross bar 90, and the plurality of second angled connector bars 100 are configured to provide a plurality of second attachment locations 104 for saddlebags 18 to be mounted to second u-shaped bracket 60 on saddlebags support device 10. However, the disclosure is not so limited and any various first attachment locations 98 on first u-shaped bracket 50 and/or second attachment locations 104 on second u-shaped bracket 60 may be included. As shown in FIG. 7, in select embodiments, first u-shaped bracket 50 and second u-shaped bracket 60 may be provided without any cross bars or angled connector bars.

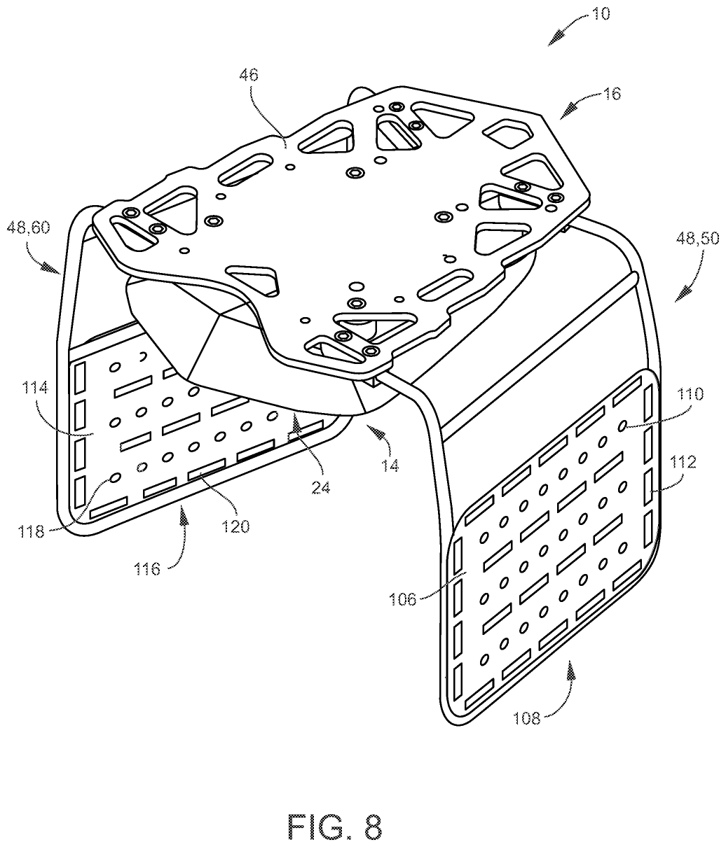

Referring now specifically to FIG. 8, in other select embodiments of the disclosed saddlebags support device 10, first u-shaped bracket 50 may include first mounting rack 106. First mounting rack 106 may be positioned approximate first distal end 108 of first u-shaped bracket 50. First mounting rack 106 may include a plurality of first holes 110 and/or a plurality of first slots 112 configured for mounting saddlebags 18 to first u-shaped bracket 50. First holes 110 and/or first slots 112 may allow for the option for various hard (or soft) saddlebags 18 to be attached to first u-shaped bracket 50. Likewise, second u-shaped bracket 60 may include second mounting rack 114. Second mounting rack 114 may be positioned approximate second distal end 116 of second u-shaped bracket 60. Second mounting rack 114 may include a plurality of second holes 118 and/or a plurality of second slots 120 configured for mounting saddlebags 18 to second u-shaped bracket 60. Second holes 118 and/or second slots 120 may allow for the option for various hard (or soft) saddlebags 18 to be attached to second u-shaped bracket 60.

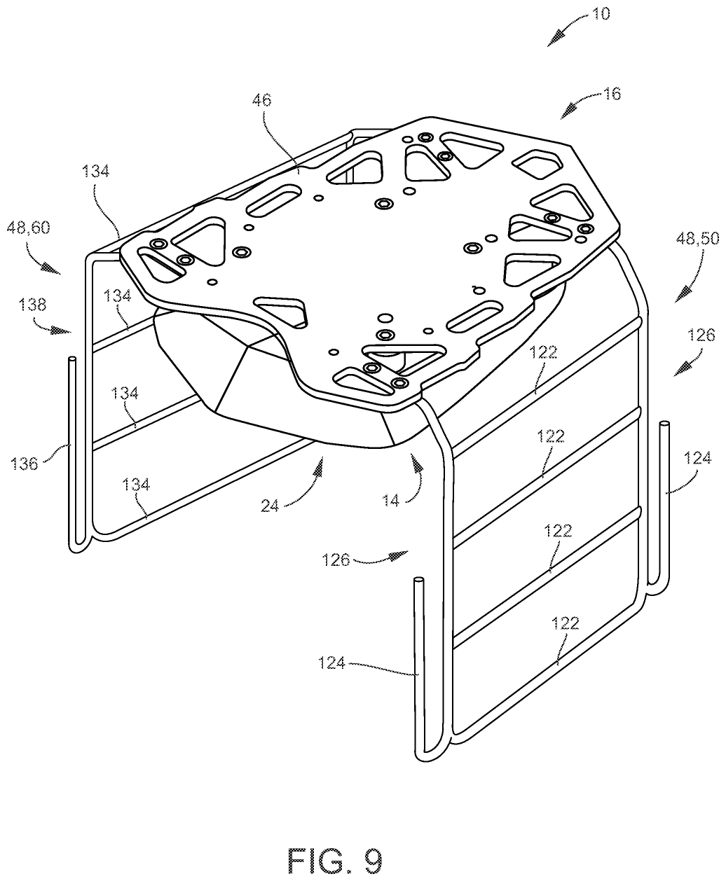

Referring now specifically to FIGS. 9 and 10, in other select embodiments of the disclosed saddlebags support device 10, first u-shaped bracket 50 may include a plurality of first cross bars 122, and first vertical open ended bars 124 on each side 126 of first u-shaped bracket 50. As shown in FIG. 10, the first vertical open ended bars 124 may be configured to be positioned in first vertical slots 128 in custom saddlebags 130 for first u-shaped bracket 50. First cross bars 122 may be configured to receive first horizontal attachment means 132 on custom saddlebags 130. Likewise, second u-shaped bracket 60 may include plurality of second cross bars 134, and second vertical open ended bars 136 on each side 139 of second u-shaped bracket 60. As shown in FIG. 10, second vertical open ended bars 136 may be configured to be positioned in second vertical slots 138 in custom saddlebags 130 for second u-shaped bracket 60. Second cross bars 134 may be configured to receive second horizontal attachment means 140 on the custom saddlebags 130.

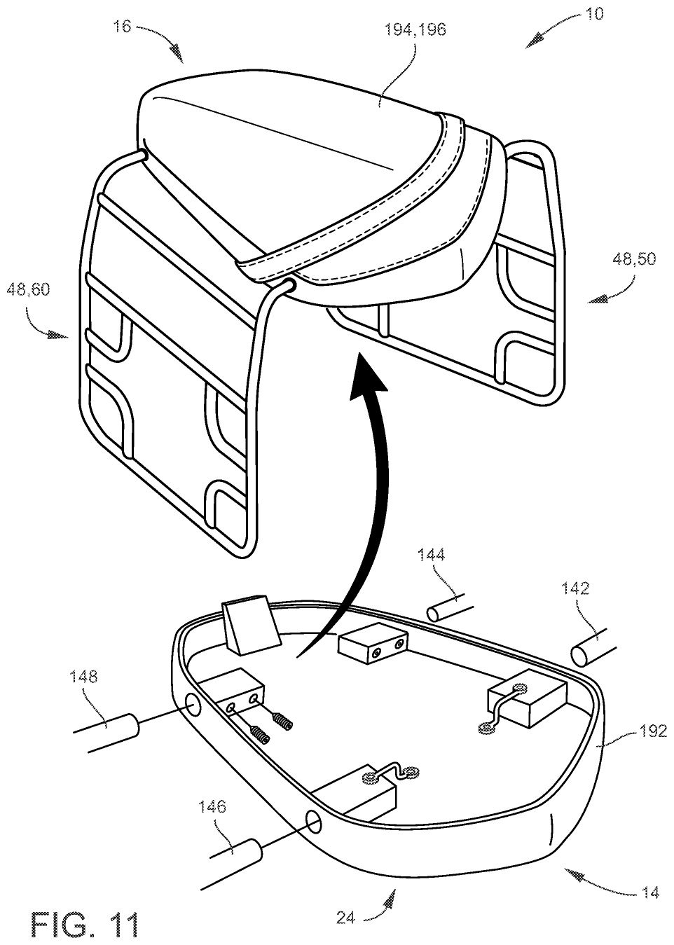

Referring now specifically to FIGS. 5 and 11, in other select embodiments of the disclosed saddlebags support device 10, first u-shaped bracket 50 may include first front end 142 and first back end 144. As shown in FIG. 5, in select embodiments, first front end 142 and first back end 144 may be affixed between mounting plate 46 and bottom portion 14. Likewise, second u-shaped bracket 60 may include second front end 146 and second back end 148. Second front end 146 and second back end 148 may be affixed between mounting plate 46 and bottom portion 14. In select embodiments, first front end 142 of first u-shaped bracket 50 may include a plurality of first front end holes 150, wherein first front end 142 may be affixed between mounting plate 46 and bottom portion 14 via a plurality of first front end mechanical fasteners 152 positioned through the plurality of first front end holes 150. Likewise, first back end 144 of the first u-shaped bracket 50 may include a plurality of first back end holes 154, wherein first back end 144 may be affixed between mounting plate 46 and bottom portion 14 via a plurality of first back end mechanical fasteners 156 positioned through the plurality of first back end holes 154. Likewise, second front end 146 of second u-shaped bracket 60 may include a plurality of second front end holes 158, wherein the second front end 146 may be affixed between mounting plate 46 and bottom portion 14 via a plurality of second front end mechanical fasteners 160 positioned through the plurality of second front end holes 158. Likewise, second back end 148 of second u-shaped bracket 60 may include a plurality of second back end holes 162, wherein the second back end 148 may be affixed between mounting plate 46 and bottom portion 14 via a plurality of second back end mechanical fasteners 164 positioned through the plurality of second back end holes 162. As shown in FIG. 5, in select embodiments, first front end mechanical fasteners 152 may include first front end bolts and nuts 166 with first front end spacers 168 between first front end 142 and bottom portion 14. Likewise, first back end mechanical fasteners 156 may include first back end bolts and nuts 170 with first back end spacers 172 between first back end 144 and bottom portion 14. Likewise, second front end mechanical fasteners 160 may include second front end bolts and nuts 174 with second front end spacers 176 between second front end 146 and bottom portion 14. Likewise, second back end mechanical fasteners 164 may include second back end bolts and nuts 178 with second back end spacers 180 between second back end 148 and bottom portion 14.

Referring to FIGS. 4-5 and 8-9, another feature of the disclosed saddlebags support device 10 may be that mounting plate 46 can include a plurality of openings 182. The plurality of openings 182 in the mounting plate 46 may be positioned approximately around 188 perimeter of mounting plate 46. The plurality of openings 182 may be configured to provide a plurality of connection points 184 for securing saddlebags 18 on saddlebag support brackets 48 of saddlebags support device 10.

Still referring to FIGS. 4-5 and 8-9, another feature of the disclosed saddlebags support device 10 may be that the mounting plate 46 can include a plurality of angles 186 around perimeter 188 of mounting plate 46. The plurality of angles 186 may be configured for providing various strapping angles 190 for mounting saddle bags 18 on saddlebag support brackets 48 of saddlebags support device 10.

Referring now specifically to FIG. 11, in other select embodiments of the disclosed saddlebags support device 10, top portion 16 may include mounting ring 192. Mounting ring 192 may include rear seat 194 or seat cowl 196 attached thereto on top portion 16. Mounting ring 192 may be configured to mount saddlebag support brackets 48 to said top portion 16 with rear seat 194 or seat cowl 196 positioned on top. By using mounting ring 192, saddlebag support brackets 48 may be configured to mount saddlebags 18 thereto with rear seat 194 or seat cowl 196 included with the disclosed saddlebags support device 10.

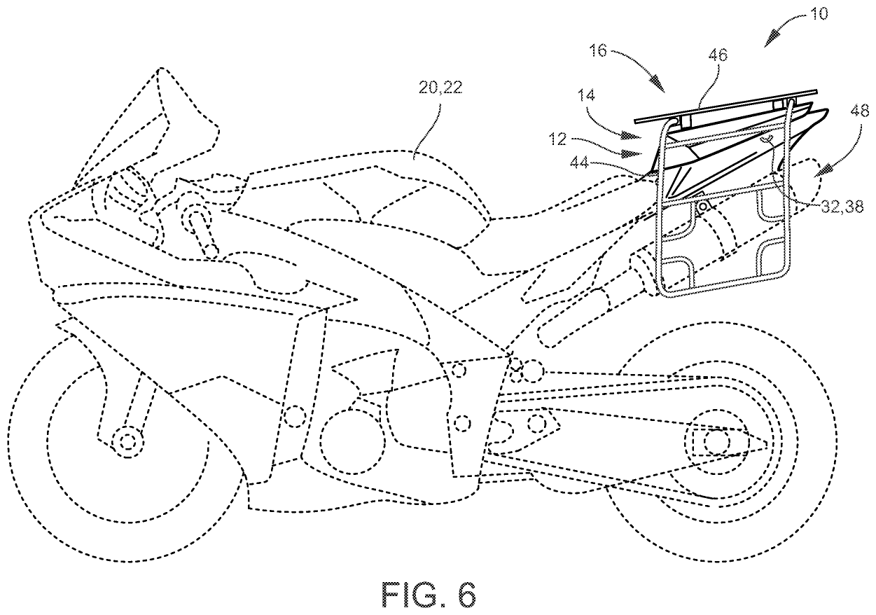

Referring now to FIG. 6. another feature of the disclosed saddlebags support device 10 may be that the saddlebags support device 10 does not require any modification to motorcycle 20 or sport bike 22 for securing saddlebag support device 10 to motorcycle 20 or sport bike 22. The disclosed saddlebags support device 10 is designed and configured to be attached to motorcycle 20 or sport bike 22 by only using rear seat cowl position well 12, like by utilizing the standard first securing hook 32, second securing hook 38, and lock 44 providing in such standard rear seat cowl position well 12.

Referring to FIGS. 4-11, another feature of the disclosed saddlebags support device 10 may be that the saddlebags support device 10 may be configured to be removed from the motorcycle with the saddlebags attached thereto. This feature of saddlebags support device 10 may provide a device or means for quickly securing and/or removing saddlebags 18 and/or custom saddlebags 130 from motorcycle 20 or sport bike 22. Saddlebags support device 10 may be removed from motorcycle 20 or sport bike 22 by releasing lock 44 from locking tab 40 and then removing bottom portion 14 from rear seat cowl position well 12 of motorcycle 20 or sport bike 22. By configuring saddlebags support device 10 to be removed from motorcycle 20 or sport bike 22 with saddlebags 18 and/or custom saddlebags 130 attached thereto, once you attach and secure saddlebags 18 or custom saddlebags 130 to this system you never have to un-attach from the system ever. The saddle supports and the saddlebags become one complete piece that may attach and un-attach as one

In another aspect, the instant disclosure embraces the disclosed saddlebags support device 10 in any of the various embodiments and/or combinations of embodiments shown and/or described herein.

In another aspect, the instant disclosure embraces a saddlebags support device 10 configured to attach to rear seat cowl position well 12 of sport bike 22 including bottom portion 14 and top portion 16. Bottom portion 14 may be configured to attach to the rear seat cowl position well 12 of sport bike 22. Top portion 16 may be connected to bottom portion 14. As a result, top portion 16 may be configured to attach saddlebags 18 on saddlebags support device 10 while positioned in rear seat cowl position well 12 of sport bike 22.

In another aspect, the instant disclosure embraces a support device 10 configured to attach to rear seat cowl position well 12 of motorcycle 20 including bottom portion 14 and top portion 16. Bottom portion 14 may be configured to attach to rear seat cowl position well 12 of motorcycle 20, or the like. Top portion 16 may be connected to bottom portion 14. Top portion 16 may include mounting plate 46. The mounting plate 46 may include a plurality of openings 182 and/or a plurality of angles 186. The plurality of openings 182 in the mounting plate 46 may be around perimeter 188 of the mounting plate 46. The plurality of openings 182 may be configured to provide a plurality of connection points 184 configured for securing luggage, saddlebags 18, or other hauled objects on mounting plate 46. The plurality of angles 186 may be around perimeter 188 of mounting plate 46. The plurality of angles 186 may be configured for providing various strapping angles 190 for mounting the luggage, the saddlebags 18 or the other hauled objects on mounting plate 46. As such, the disclosed support device 10 may include mounting plate 46 with or without any saddlebag support brackets 48 attached thereto.

A feature of the present disclosure of saddlebag support device 10 may be its ability to attach and unattached to motorcycle 20, sport bike 22, or the like in seconds.

Another feature of the present disclosure of saddlebag support device 10 may be its ability to not permanently bolt to and clutter up motorcycle 20, sport bike 22, or the like. Saddlebag support device 10 may be a separate system that replaces rear seat 2 or rear seat cowl 3 of an existing motorcycle 20, sport bike 22, or the like.

Another feature of the present disclosure of saddlebag support device 10 may be its ability to haul cargo, and top cargo bag and saddlebags 18, or the like.

In sum, the disclosed saddlebag support device 10 may be designed and configured to replace the rear seat 2 or rear seat cowl 3 of a motorcycle 20, like sport bike 22, with a device configured to hold saddlebags 18 and/or luggage on the sport bike 22. Saddlebag support device 10 may be designed to use the same connection mechanisms or points 24 that the rear seat 2 or rear seat cowl 3 has that will allow the device to be easily substituted on and off with the actual rear seat cushion. Saddlebag support device 10 could have various embodiments, including just a luggage rack embodiment, brackets configured for attaching soft saddle bags, brackets configured for attaching hard saddlebags, the like etc.

Another best benefit of the disclosed saddlebag support device 10 over any other known saddlebag support system may be that other systems you have to take time to attach and un-attach the saddlebags from the saddlebag supports every time you install them on the bike. With saddlebag support device 10, once you attach and secure saddlebags 18 or custom saddlebags 130 to this system you never have to un-attach from the system ever. The saddle supports and the saddlebags become one complete piece that may attach and un-attach as one.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A saddlebags support device configured to attach to a rear seat cowl position well comprising:
a bottom portion configured to be removably attached to the rear seat cowl position well; and
a top portion connected to the bottom portion, the top portion is configured to attach saddlebags on the saddlebags support device while positioned in the rear seat cowl position well.

2. The saddlebags support device of claim 1, wherein the rear seat cowl position well is on a motorcycle, wherein:
the bottom portion of the saddlebags support device is configured to attach to the rear seat cowl position well of the motorcycle; and
the top portion of the saddlebags support device is configured to attach the saddlebags on the saddlebags support device while positioned in the rear seat cowl position well of the motorcycle.

3. The saddlebags support device of claim 2, wherein the motorcycle is a sport bike and the rear seat cowl position well is on the sport bike, wherein:
the bottom portion of the saddlebags support device is configured to attach the saddlebags on the saddlebags support device while positioned in the rear seat cowl position well of the sport bike; and
the top portion of the saddlebags support device is configured to attach the saddlebags on the saddlebags support device while positioned in the rear seat cowl position well of the sport bike.

4. The saddlebags support device of claim 1, wherein the bottom portion including a plurality of standard connection points configured to secure the bottom portion in the rear seat cowl position well.

5. The saddlebags support device of any one of claim 4, wherein the plurality of standard connection points including:
a first hook receiver positioned approximate a back end of the bottom portion approximate a first bottom side of the bottom portion, the first hook receiver is configured to receive a first securing hook in the rear seat cowl position well;
a second hook receiver positioned approximate the back end of the bottom portion approximate a second bottom side of the bottom portion, the second hook receiver is configured to receive a second securing hook in the rear seat cowl position well;
a locking tab extended from the bottom portion and positioned approximate a front end of the bottom portion, the locking tab is configured to engage a lock in the rear seat cowl position well;
whereby:
when the bottom portion of the saddlebags support device is positioned in the rear seat cowl position well with the first securing hook inserted into the first hook receiver and the second securing hook inserted into the second hook receiver, the bottom portion of the saddlebags support device is configured to be locked into the rear seat cowl position well via the lock engaging the locking tab under the bottom portion; and
when the lock is disengaged from the locking tab, the saddlebags support device is configured to be removed from the rear seat cowl position well.

6. The saddlebags support device of claim 1, wherein the top portion including a mounting plate, the mounting plate is configured to mount at least one saddlebag support bracket to said top portion, each of the at least one saddlebag support brackets is configured to mount the saddlebags thereto.

7. The saddlebags support device of claim 6, wherein the at least one saddlebag support bracket including:
a first u-shaped bracket including:
a first horizontal starting portion connected to a first side of the mounting plate and extending horizontally therefrom the first side of the mounting plate;
a first vertical ending portion extending vertically down from the first horizontal starting portion; and
at least one first bend between the first horizontal starting portion and the first vertical ending portion;
a second u-shaped bracket including:
a second horizontal starting portion connected to a second side of the mounting plate and extending horizontally therefrom the second side of the mounting plate;
a second vertical ending portion extending vertically down from the second horizontal starting portion; and
at least one second bend between the second horizontal starting portion and the second vertical ending portion.

8. The saddlebags support device of claim 7, wherein:
the first u-shaped bracket including:
an upper first bend with an upper first cross bar;
a lower first bend with a lower first cross bar;
a first ending cross bar at a first bottom of the first u-shaped bracket;
the second u-shaped bracket including:
an upper second bend with an upper second cross bar;
a lower second bend with a lower second cross bar; and
a second ending cross bar at a second bottom of the second u-shaped bracket.

9. The saddlebags support device of claim 8, wherein:
the first u-shaped bracket including:
a plurality of first angled connector bars connected in each first corner between the lower first cross bar and the first ending cross bar;
wherein, the upper first cross bar, the lower first cross bar, the first ending cross bar, and the plurality of first angled connector bars are configured to provide a plurality of first attachment locations for the saddlebags to be mounted to the first u-shaped bracket on the saddlebags support device;
the second u-shaped bracket including:
a plurality of second angled connector bars connected in each second corner between the lower second cross bar and the second ending cross bar; and
wherein, the upper second cross bar, the lower second cross bar, the second ending cross bar, and the plurality of second angled connector bars are configured to provide a plurality of second attachment locations for the saddlebags to be mounted to the second u-shaped bracket on the saddlebags support device.

10. The saddlebags support device of claim 7, wherein:
the first u-shaped bracket including:
a first mounting rack positioned approximate a first distal end of the first u-shaped bracket, the first mounting rack including a plurality of first holes and a plurality of first slots configured for mounting saddlebags to the first u-shaped bracket; and
the second u-shaped bracket including:
a second mounting rack positioned approximate a second distal end of the second u-shaped bracket, the second mounting rack including a plurality of second holes and a plurality of second slots configured for mounting the saddlebags to the second u-shaped bracket.

11. The saddlebags support device of claim 7, wherein:
the first u-shaped bracket including:
a plurality of first cross bars;
first vertical open ended bars on each side of the first u-shaped bracket;
the first vertical open ended bars are configured to be positioned in first vertical slots in custom saddlebags for the first u-shaped bracket;
the plurality of first cross bars are configured to receive first horizontal attachment means on the custom saddlebags;
the second u-shaped bracket including:
a plurality of second cross bars;
second vertical open ended bars on each side of the second u-shaped bracket;
the second vertical open ended bars are configured to be positioned in second vertical slots in the custom saddlebags for the second u-shaped bracket; and
the plurality of second cross bars are configured to receive second horizontal attachment means on the custom saddlebags.

12. The saddlebags support device of claim 7, wherein:
the first u-shaped bracket including a first front end and a first back end, the first front end and the first back end are affixed between the mounting plate and the bottom portion; and
the second u-shaped bracket including a second front end and a second back end, the second front end and the second back end are affixed between the mounting plate and the bottom portion.

13. The saddlebags support device of claim 12, wherein:
the first front end of the first u-shaped bracket including a plurality of first front end holes, wherein the first front end is affixed between the mounting plate and the bottom portion via a plurality of first front end mechanical fasteners positioned through the plurality of first front end holes;
the first back end of the first u-shaped bracket including a plurality of first back end holes, wherein the first back end is affixed between the mounting plate and the bottom portion via a plurality of first back end mechanical fasteners positioned through the plurality of first back end holes;
the second front end of the second u-shaped bracket including a plurality of second front end holes, wherein the second front end is affixed between the mounting plate and the bottom portion via a plurality of second front end mechanical fasteners positioned through the plurality of second front end holes; and
the second back end of the second u-shaped bracket including a plurality of second back end holes, wherein the second back end is affixed between the mounting plate and the bottom portion via a plurality of second back end mechanical fasteners positioned through the plurality of second back end holes.

14. The saddlebags support device of claim 13, wherein:
the first front end mechanical fasteners include first front end bolts and nuts with first front end spacers between the first front end and the bottom portion;
the first back end mechanical fasteners include first back end bolts and nuts with first back end spacers between the first back end and the bottom portion;
the second front end mechanical fasteners include second front end bolts and nuts with second front end spacers between the second front end and the bottom portion; and
the second back end mechanical fasteners include second back end bolts and nuts with second back end spacers between the second back end and the bottom portion.

15. The saddlebags support device of claim 6, wherein the mounting plate including a plurality of openings approximately around a perimeter of the mounting plate, the plurality of openings is configured to provide a plurality of connection points for securing the saddlebags on the saddlebag support brackets.

16. The saddlebags support device of claim 6, wherein the mounting plate including a plurality of angles around a perimeter of the mounting plate, the plurality of angles is configured for providing various strapping angles for mounting saddle bags on the saddlebags support device.

17. The saddlebags support device of claim 1, wherein the top portion including a mounting ring with a rear seat or a seat cowl attached thereto, the mounting ring is configured to mount saddlebag support brackets to said top portion, the saddlebag support brackets are configured to mount the saddlebags thereto.

18. The saddlebags support device of claim 1, wherein:
the saddlebags support device does not require any modification to a motorcycle or a sport bike for securing the saddlebag support device to the motorcycle or the sport bike;
the saddlebags support device is configured to be removed from the motorcycle with the saddlebags attached thereto.

19. A saddlebags support device configured to attach to a rear seat cowl position well of a sport bike comprising:
a bottom portion configured to attach to the rear seat cowl position well of the sport bike; and
a top portion connected to the bottom portion, the top portion is configured to attach saddlebags on the saddlebags support device while positioned in the rear seat cowl position well of the sport bike.

20. A support device configured to attach to a rear seat cowl position well of a motorcycle comprising:
a bottom portion configured to attach to the rear seat cowl position well of the motorcycle;
a top portion connected to the bottom portion, the top portion including a mounting plate, the mounting plate;
wherein the mounting plate including:
a plurality of openings around a perimeter of the mounting plate, the plurality of openings is configured to provide a plurality of connection points configured for securing luggage, saddlebags, or other hauled objects on the mounting plate;
a plurality of angles around the perimeter of the mounting plate, the plurality of angles is configured for providing various strapping angles for mounting the luggage, the saddlebags or the other hauled objects on the mounting plate; or
a combination thereof.
